(19) United States
(12) Patent Application Publication
(10) Pub. No.: US 2007/0075125 A1
(43) Pub. Date: Apr. 5, 2007

(54) Packaging and process of authenticating packaging

(76) Inventor: Robert G. Muscat, Alpharetta, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/241,195

(22) Filed: Sep. 30, 2005

(51) Int. Cl. G06F 17/00

(52) U.S. Cl. 235/375

(57) ABSTRACT

A process for authenticating packaged goods from a remote location using existing communication devices and communication networks is described. The process preferably comprises a serial number and authentication code printed on a package. A user can transmit the serial number to an authentication authority via phone or internet or any other communication device. The authentication authority determines if the serial number transmitted by the user is a valid serial number and, if so, transmits an authentication code to the user. The user can compare the authentication code received from the authentication authority to the authentication code on the package and verify the authenticity of the goods.

### FIELD OF THE INVENTION

Certain embodiments of the present invention relate to packaging and a process for packaging with authentication features, and more specifically to packaging and a process for packaging that allows for remote authentication via phone, email or any type of communication means.

### BACKGROUND

Technology advances and the lowering of trade barriers continually enhance the growing global economy. Such growth has led to increased traffic of consumer goods through international trade channels. However, with the increase of consumer good traffic, problems have arisen with gray market goods, criminal subversion, and/or counterfeiting.

Often when crossing international borders, goods are stopped for inspection by local customs authorities. The United States Customs Department allows for U.S. registered trademark holders to record trademarks with the customs authority. When goods bearing the recorded mark or a mark substantially similar to the recorded mark enter the United States, they are stopped by the customs authority and inspected for authenticity. The sophistication of counterfeit goods and the existence of gray market goods and parallel imports has made it difficult for customs inspectors to determine which goods are authentic and which are not. Therefore, many manufacturers and trademark holders have turned to security measures associated with their product packaging and branding strategies to ensure authenticity of goods.

Recent methods of authentication of product packaging and brand protection have focused on adding authentication mechanisms to existing product packaging. These attempts at authentication include the use of labels or seals that are applied to the product packaging containing a security identifier. One example of such a security mechanism is the use of a hologram as an identifier of authenticity. Holograms may be printed on an adhesive label which can be placed on the product packages.

### SUMMARY

Certain embodiments of the invention provide a product package which can be authenticated by a user and process for authenticating a packaged product using common communication devices. According to certain embodiments, a serial number or code can be generated in connection with a product and printed on the product packaging. An authentication code or number is preferably generated for each serial number. The serial number and authentication code are preferably located on the product package, with the authentication code covered or obscured from vision, for example by a coin abrasive material. The serial number and authentication code are preferably stored by an authentication authority in a single location.

The packaged product can be distributed through the stream of commerce from the packaging facility to an end user. This may involve passing through customs if the product is being imported. A party, such as a customs agent or a user, seeking to authenticate the package can do so from a remote location according to certain aspects of the invention. The user may preferably transmit the serial number on the package to the authentication authority. This can be done by telephone, facsimile, mobile phone, text messaging, electronic mail, secure web site or any other type of communication means. Once the serial number is received by the authentication authority, the authentication authority preferably determines if the serial number matches one of the serial numbers stored by the authentication authority. If the serial number received from the user matches a serial number stored by the authentication authority, the authentication authority preferably transmits the authentication code corresponding to the serial number to the user. The user may compare the authentication code received from the authentication authority to the authentication code on the package. If the two authentication codes are the same, the user can be assured that the packaged products are authentic.

### BRIEF DESCRIPTION OF THE DRAWINGS

FIG. 1 is a flow chart describing a process according to certain embodiments of the invention.

FIG. 2 is a block diagram according to certain embodiments of the invention.

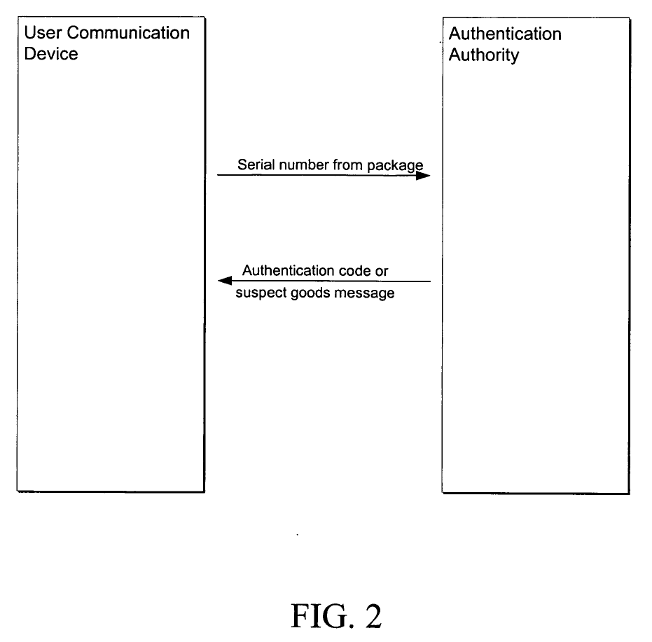

### DETAILED DESCRIPTION

In order to more effectively prevent counterfeiting of goods and identification of gray market goods, certain embodiments of the present invention comprise packaging and a method of packaging that allows authentication from a remote location. By utilizing existing communication channels and communication devices, certain embodiments of the present invention provide the ability to remotely authenticate products and product packaging at minimal cost.

According to certain embodiments of the invention, products may be packaged in a product packaging of some type containing a serial number or code. The serial number may be used to authenticate the product if desired. For example, the person desiring to determine if the packaged goods are authentic may call an authentication center and provide the serial number on the packaged goods. The authentication center will preferably respond with a response code. The person receiving the response code information may then compare the response code to the response code printed on the packaging, which may be obscured by a coin abrasive covering. If the response codes match, the goods can be identified as authentic. Alternatively, if the codes do not match, the goods may be identified as counterfeit.

According to certain embodiments, the serial number placed on the product packaging may be a serial number associated with a UPC barcode. The serial number may be generated by the product manufacturer or at the packaging facility if separate from the product manufacturing facility. The serial number may preferably be generated according to standard procedures of generating barcodes known to those skilled in the art, and may include both alpha and numeric characters if desired. Alternatively, the serial number may be generated by a random code generator and may include just alphabetic characters, just numbers or both alpha and numeric characters and even other symbols if desired.

It should be understood that according to certain embodiments of the invention, the serial number or code may be generated for authentication purposes only and be unrelated to the UPC barcode if desired. The authentication code may include just alphabetic characters, just numbers or both alpha and numeric characters, and may be randomly generated. Alternatively, the authentication code may be a word or series of words such as a phrase of some sort. The serial number or code placed on packaged product may be different for each product or alternatively the same serial number may be placed on a batch of packaged products if desired. For example, the same serial number may be placed on all products packaged on a particular day and a different serial number used for products packaged on each different day if desired. It should be understood that serial numbers may be applied to product packaging in any incremental batch as desired, however, changing the serial number on a somewhat frequent basis may provide additional security measures to the authentication process and make counterfeiting of the packaged products more difficult.

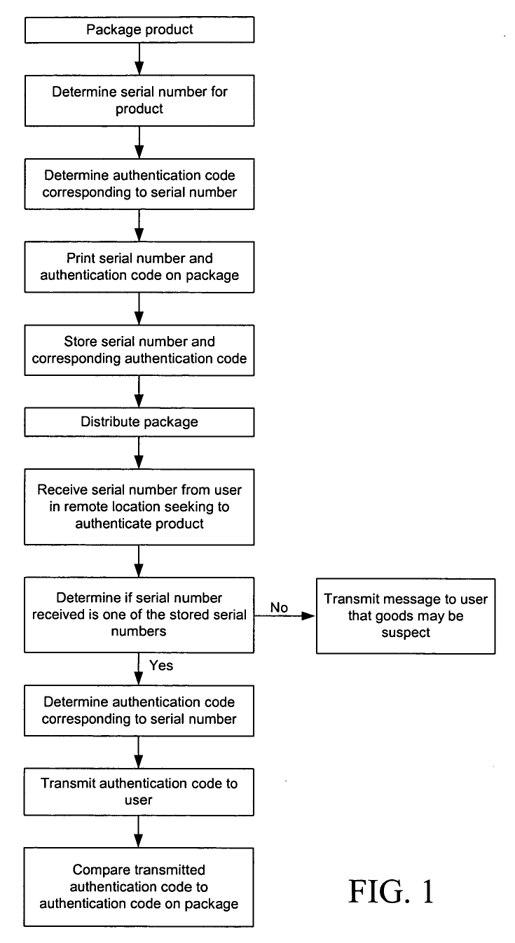

Certain embodiments of the invention provide a process for determining authenticity of any type of packaged goods. As shown in FIG. 1, the packaging associated with the a particular product may preferably include a serial number or code which may be located on the packaging itself. The serial number may or may not be associated with the UPC barcode as desired. Those skilled in the art will know that a UPC barcode may include several fields of information represented by alpha and numeric characteristics. The serial number may be changed for each individual product or alternatively one serial number may be used for a batch of products as desired.

Once the serial number or code for a product has been generated, it is preferable to generate an authentication code for each serial number. The authentication code may preferably be generated by the packaging facility. Alternatively, the authentication code may be generated by a third party and transmitted to the packaging facility if desired. Each serial number preferably correlates to a single authentication code. The authentication code is printed on the packaging and preferably covered by a coin abrasive substance or a chemical treatment obscuring the authentication code from view. The chemical treatment may preferably be a treatment of ink that when exposed to air or light will react and darken after a short period of time. The authentication code may be covered by a protective cover which when removed allows the user to see the code for a brief amount of time prior to the reaction that caused the area to darken and the code to become unreadable. The authentication code may be a random collection of alpha, numeric, and/or symbolic characters or may be a word or a phrase if desired.

The serial number/code and corresponding authentication code for each package should preferably be stored in a single place, and preferably in a secure database. The entity responsible for storing the serial numbers and authentication codes may be referred to as an authentication authority for reasons described below. If the packaging facility itself is the authentication authority, the serial numbers and correlating authentication codes should preferably be stored in a single, password protected database. Alternatively, a third party may act as the authentication authority if desired. In that case, the serial numbers and authentication codes are preferably securely transmitted to the third party authentication authority and preferably stored by the authentication authority in a single secure database. Once transmitted from the packaging facility and receipt by the authentication authority is confirmed, the serial numbers and authentication codes are preferably immediately destroyed. Thus, preferably only the authentication authority maintains the serial numbers and matching authentication codes.

The product containing the serial number and the preferably visually obscured authentication code can be distributed according to its usual supply chain. A party, such as a customs agent or a purchaser of the product, wishing to determine if the product is authentic may do so from a remote location using existing communication lines and communication devices. For example, the party desiring to determine if the product is authentic may call the authentication authority and transmit the serial number. The authentication authority will preferably consult the database and determine if it recognizes the serial number and determine the matching authentication code for the serial number. If the serial number is recognized, the authentication authority will preferably respond by identifying the authentication code. The party desiring to determine the authenticity of the goods may then compare the authentication code received from the transmission authority with the authentication code on the product package. If the authentication code on the product package has been obscured by a coin abrasive covering or some other type of coating, the covering should be removed, exposing the authentication code on the product packaging. If the authentication code received from the authentication authority matches the authentication code on the packaging, the goods can be identified as authentic. If the authentication authority does not recognize the serial number, the authentication authority may respond by informing by indicating no record of the serial number was found and the goods may be suspect.

The party wishing to authenticate the product may also do so over other communication lines such as landline, mobile and cellular phones, SMS text messaging, networked computer systems, web based systems, secure web sites and others. The authentication can be done using a telephone, facsimile, cell phone, pager, text messager, personal computer, lap top, PDA, Blackberry, portable e-mail devices, or any other communication device. It should be understood that the authentication code may be transmitted to the user by a different communication means than that used by the user when transmitting the serial number or code to the authentication authority if desired. For example, the user may enter the serial number into a secure web site and the authentication code may be e-mailed to the user if desired.

According to certain embodiments of the invention, the authentication authority may preferably transmit more information than just the response code once the serial number/code is recognized. For example, the authentication authority may also transmit the product name, place of manufacture, date of manufacture, shipping destination and any other information in addition to the authentication code if desired. It should also be understood that the authentication authority may transfer additional information if the serial number is not recognized. For example, the authentication authority may provide instructions of what to do with the suspect product if the serial number is not recognized. Certain embodiments of the invention may only allow authentication of the product one time. Alternatively, certain embodiments of the invention may allow for the product to be authenticated multiple times if desired.

According to certain embodiments of the invention, a product may be required to be authenticated multiple times along the distribution chain from manufacturing facility to end customer. There may be multiple authentication codes associated with each serial number if desired. For example, if the product is to be authenticated by customs officials upon entry into the United States and by the consumer, the authentication code transmitted to the customs officials may be different from the authentication code transmitted to the consumer. In such a case, the customs officials should be told where to find the relevant authentication code on the packaging either in advance or by the authentication authority when the authentication code is transmitted. Similarly, the consumer should preferably be told where to locate the appropriate authentication code on the package. It should be understood that certain embodiments of the invention may also provide multiple serial numbers and matching authentication codes if desired.

While this invention has been described in detail with particular reference to the disclosed embodiments, it will be understood that variations and modifications can be affected within the spirit and scope of the invention as described herein and as defined in the appended claims.

That which is claimed:

1. A process for packaging goods and providing the ability to authenticate the packaged goods from a remote location, comprising:
packaging a product in a product packaging;
determining a serial number in connection with the packaged product;
determining an authentication code for each serial number;
storing the serial number and matching authentication code;
providing the serial number and authentication code on the package;
distributing the packaged product; and
receiving a serial number from a user in a remote location and determining if the received serial number is identical to one of the stored serial numbers;
transmitting the matching authentication code to the user whereby the user can determine if the packaged goods are authentic by comparing the transmitted authentication code to the authentication code on the package.

2. The process according to claim 1, wherein the authentication code located on the package is covered by a coin abrasive material.

3. The process according to claim 1, wherein the serial number and matching authentication code are stored in a single storage medium.

4. The process according to claim 1, wherein the serial number is received from the user in a remote location via a mobile phone link.

5. The process according to claim 1, wherein the serial number is received from the user in a remote location via electronic mail.

6. The process according to claim 1, wherein the serial number is received from the user in a remote location via a web based link.

7. The process according to claim 1, wherein the serial number is a UPC barcode.

8. The process according to claim 1, further comprising destroying all other copies of the serial number and matching authentication code after storing the serial number and matching authentication code in single storage medium.

9. The process according to claim 1, wherein the serial number is a combination of alpha and numeric characters.

10. A product packaging comprising:
a serial code printed on the packaging; and
an authentication code associated with the serial code, the authentication coder printed on the product packaging and covered by a coin abrasive material;
wherein a user receiving the product packaging can determine its authenticity by transmitting the serial code to a authentication authority and receiving from the authentication authority an authentication code which matches the authentication code printed on the package once the coin abrasive material is removed.

11. The product packaging according to claim 10, wherein the user transmits the serial number to the authentication authority by mobile phone.

12. The product packaging according to claim 10, wherein the user transmits the serial number to the authentication authority by SMS text messaging.

13. The product packaging according to claim 10, wherein the user transmits the serial number to the authentication authority through a secure web site.

14. The product packaging according to claim 13, wherein the user receives the authentication code from the authentication authority by electronic mail.
